(19) United States
(12) Patent Application Publication
(10) Pub. No.: US 2026/0286541 A1
(43) Pub. Date: Sep. 24, 2026

(54) ELECTROLYSIS OF MOLTEN METAL OXIDES AND SUBSEQUENT USES

(71) Applicant: Rishi G. Agarwal, Palo Alto, CA (US)

(72) Inventor: Rishi G. Agarwal, Palo Alto, CA (US)

(21) Appl. No.: 19/478,270

(22) PCT Filed: May 24, 2024
(86) PCT No.: PCT/US2024/030907

§ 371 Date: Oct. 24, 2025

Related U.S. Application Data
(60) Provisional application No. 63/504,205, filed on May 25, 2023.

(51) Int. Cl. C25B 9/09; C04B 7/36; C04B 111/00; C25B 1/33; C25B 15/021

(52) U.S. Cl. CPC C25B 9/09; C04B 7/36; C25B 1/33; C25B 15/021; C04B 2111/00019

(57) ABSTRACT

An electrochemical process applies a potential across an anode and a cathode placed in a molten electrolyte. Concurrently, oxygen is provided to the cathode to cause oxide ions to be formed in the molten electrolyte near the cathode. Accordingly, a first solution of higher oxide anion activity is formed at the cathode and a second solution of lower oxide anion activity is formed at the anode.

### CROSS-REFERENCE TO RELATED APPLICATION

This application claims the benefit of priority to pending U.S. Provisional Patent Application Entitled, “Slag Production from Electrolysis”, Ser. No. 63/504,205, naming the same inventor as in the instant application, filed May 25, 2023, the contents of which are incorporated herein in their entirety.

### TECHNICAL FIELD OF INVENTION

The invention relates to electrolysis, and more specifically to electrolysis of molten metal oxides for various subsequent uses including mitigating climate change.

### BACKGROUND

The generation of acid and base via electrochemistry is valuable for multiple applications. This process has been described in aqueous electrolytes where the acid and base products have been shown to be competent to enable the carbon dioxide free production of cement and carbon dioxide removal from the atmosphere. Commercialization of these processes would be a significant technological advance, but available technologies using aqueous electrolytes currently lack the current density, concentrations, and energy efficiency required. A fundamental limitation of aqueous processes is that they produce acidic and basic solutions that must then be used to perform chemical manipulations of mined minerals. A process which can directly manipulate mined minerals would be preferable.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an oxygen shorted electrochemical cell containing cathode, anode, and molten electrolyte in an embodiment of the present disclosure.

FIG. 2 depicts the state of the cell upon electrolysis.

FIG. 3 depicts an ion activity gradient and subsequent production of solids at the cathode and anode.

### SUMMARY

An electrochemical process according to an aspect of the present disclosure applies a potential across an anode and a cathode placed in (immersed at least partially in) a molten electrolyte. Concurrently, oxygen is provided to the cathode to cause oxide ions to be formed in the molten electrolyte near the cathode. Accordingly, a first solution of higher oxide anion activity is formed at the cathode and a second solution of lower oxide anion activity is formed at the anode.

According to another aspect, the second solution (of lower oxide anion activity) is separated from the first solution, which can then be used for a variety of purposes. In an embodiment, the first solution is reacted with carbon dioxide to form a carbonate mineral.

In another embodiment, the first solution is mixed with various constituents to form cement.

In yet another embodiment, a cell housing the anode, the cathode and the electrolyte is cooled by a fluid, and that fluid is used in a thermal cycle to extract carbon dioxide from air, thereby mitigating climate change.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### DETAILED DESCRIPTION

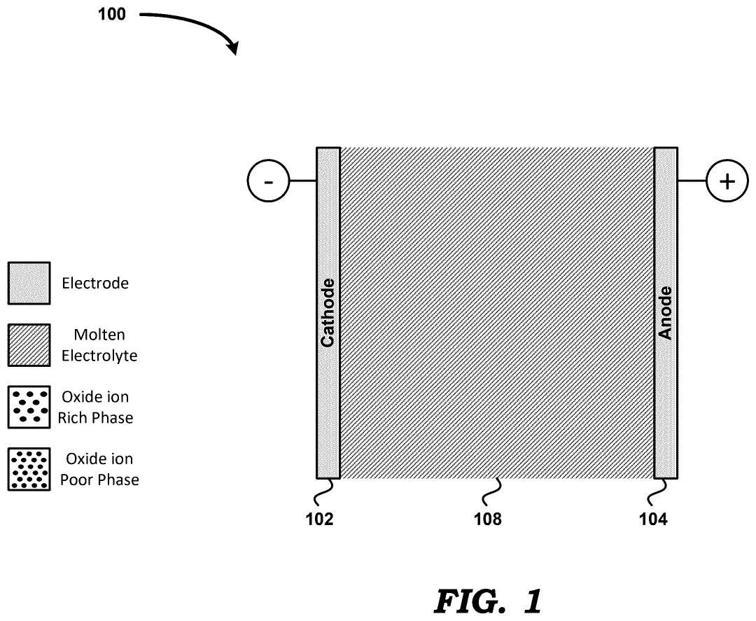

FIG. 1 illustrates an electrochemical cell 100 comprising an anode, a cathode, and an electrolyte in an embodiment of the present disclosure. A suitable housing (not shown) may be used to place the three components.

Electrolyte 108 is a mixture containing one or more metal oxides in a molten form. As is well known, oxide containing minerals, such as anorthite, wollastonite, spodumene, and quartz, and their mixtures can be heated at temperatures in the range of 1200-1800° C. to obtain the molten form. In an embodiment, electrolyte 108 contains other ionic compounds which comprise

Anode 104 and cathode 102 need to be designed to apply sufficient electricity to electrolyte 108 according to aspects of the present disclosure. In an embodiment, the anode and cathode are formed from metallic solids or liquids at the temperature of the process and a potential ranging between 0 and 20 volts is applied across them. The current densities at the cathode and anode range from 0.5 to 20 A cm⁻².

When a potential is applied across the anode and cathode, oxygen gas reacts at the cathode to form oxide ions. Conversely, at the anode, oxide ions react to produce oxygen gas. In an embodiment, the oxygen that reacts at the cathode is produced at the anode and an accordingly suitable mechanism (e.g., exhaust and pipe combination) can be employed to channel such oxygen to the cathode, depending on the environment of deployment. As an alternative, the entire electrochemical cell may be operated in a closed environment such that the oxygen generated at anode 104 is reasonably efficiently available for cathode 102. In another embodiment, the oxygen that reacts at the cathode is from the atmosphere external to the cell.

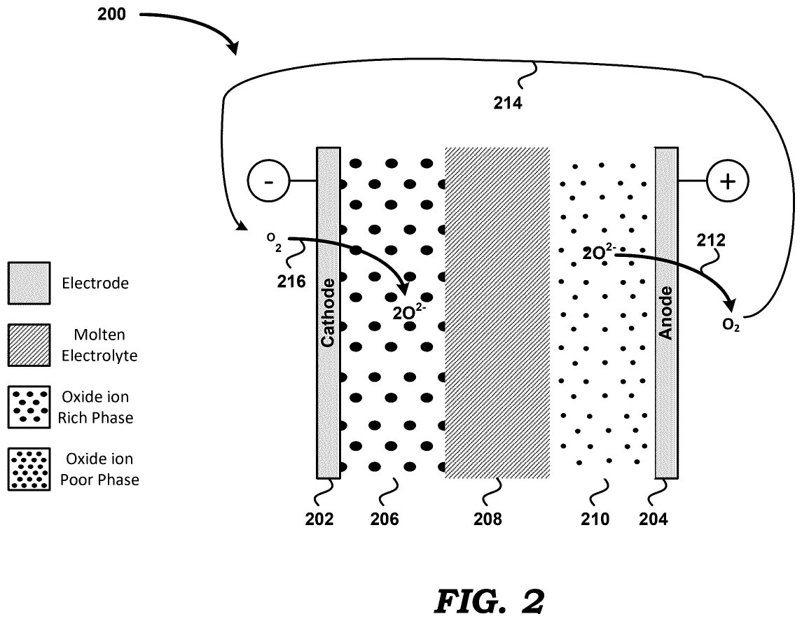

FIG. 2 depicts the state of cell 100 upon electrolysis. As shown there, due to the spatial segregation of the cathode and anode reactions, a gradient in oxide ion activity is established. The ionic character of oxide ions is increased near the cathode 206 and decreased near the anode 210 compared to the bulk 208. Thus, solution 206 has more active oxide anions compared to those in solution 210.

The ionic content of the bulk electrolyte 108 includes one or more of calcium, magnesium, and lithium. In an embodiment, formation of the oxide ion activity gradient increases the concentration of these ions near the cathode 206 as compared to the bulk 208 by a factor ranging between 1.5-10. In general, a desired composition can be obtained by applying suitable potential for a sufficient time, as will be apparent to a skilled practitioner without undue experimentation.

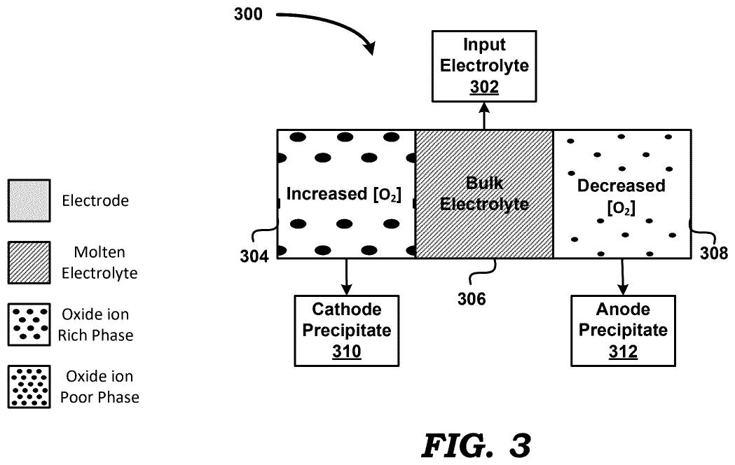

As further depicted in FIG. 3, the molten electrolyte 304 near the cathode can be separated and cooled to form a first precipitate 310, while the molten electrolyte 308 near the anode can be separated and cooled to form a second precipitate 312. In an embodiment the oxide ion activity gradient causes the electrolyte near the cathode 206 to become immiscible with the electrolyte near the anode 210. In another embodiment, the molten electrolyte near the cathode and the molten electrolyte near the anode are separated by a porous separator.

The two electrolytes are then removed from the cell, for example, by tapping. The tapping may occur at a frequency such as every 10 minutes, hour, 6 hours, or 12 hours, while the electrolysis is continuous. Outside of the cell the electrolytes 206 and 210 are quickly cooled by the ambient atmosphere to form the first precipitate 310 and the second precipitate 312. Each of the precipitates can then be used in a variety of ways.

In an embodiment in which the molten electrolyte 108 is formed from wollastonite, the first precipitate constitutes an alkaline slag containing calcium disilicate, or a solid that, when dissolved in water, raises the pH above 7. In contrast, the second precipitate constitutes an acidic slag containing silicon dioxide, or a solid that, when dissolved in water, lowers the pH below 7.

The first precipitate, which in an embodiment is comprised of a mixture containing one or more of magnesium oxide and calcium disilicate, is reacted with carbon dioxide to form a carbonate mineral. In an embodiment, the first precipitate is crushed to increase the surface area across which it can react with carbon dioxide. In an embodiment, water is introduced to increase the reaction rate between carbon dioxide and the first precipitate.

The first precipitate is crushed to form a cement. In an embodiment, the crushed first precipitate, which in an embodiment is comprised of a mixture containing one or more of calcium disilicate and alite, is mixed with one or more of water, aluminum oxide, iron oxide, calcium oxide, magnesium oxide, carbon dioxide, or silicon dioxide to form the cement.

Unlike previous implementations of electrochemical processes with molten electrolytes, the product of this process is not a reduced or oxidized material, but an oxide ion activity gradient. This gradient corresponds to an acid-alkali gradient in the Lux-Flood conception, which can be used to generate an alkaline solid and an acidic solid from the input electrolyte.

Commercial electrochemical cells which contain molten electrolytes require an energy excess or overpotential beyond the thermodynamic barrier for reaction to increase the reaction rate or to form a temperature gradient sufficient to create a frozen ledge and prevent leakage of the molten electrolyte. Recycling of this excess energy for another purpose increases the energy efficiency and cost-effectiveness of the process. The electrochemical cell (e.g., the surface that houses the electrodes and the molten electrolyte) is cooled by a fluid with an initial temperature between 0 and 1000° C. The fluid once heated the fluid transfers its heat to a third solid which upon heating releases carbon dioxide bound to it. The third solid is put in contact with air until it once again binds carbon dioxide (thereby mitigating climate change). The fluid, now cooled, is returned to the cell to be reheated. The cycle repeats. In an embodiment, the fluid is comprised of at least one of air and water.

One implementation of this technology would be to use an abundant calcium aluminosilicate, such as anorthite (melting point of 1553° C.), as the primary component of the molten oxide electrolyte. Further metal oxide additives (e.g., calcium oxide, aluminum oxide, magnesium oxide) might be added to control the composition of either the first or second solid. Potential compositions for the first precipitate include dicalcium silicate or another calcium-rich phase, whereas the second precipitate might have the composition of silicon dioxide or another calcium-poor phase.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently general, flexible and configurable, such that it may be utilized in ways other than that shown in the accompanying figures and with other types of metal oxides, etc.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

### REFERENCES

1. Allanore, Antoine, Lan Yin, and Donald R. Sadoway. “A new anode material for oxygen evolution in molten oxide electrolysis.” Nature 497, no. 7449 (May 8, 2013): 353-356.
2. Ellis L D, Badel A F, Chiang M L, Park R J, Chiang Y M. “Toward electrochemical synthesis of cement-An electrolyzer-based process for decarbonating CaCO3 while producing useful gas streams.” Proc. Natl. Acad. Sci. U.S.A. (Jun. 9, 2020); 117(23): 12584-12591.

What is claimed is:

1. An electrochemical process comprising:
applying a potential across an anode and a cathode immersed at least partly in an electrolyte containing metal oxide in molten form; and
providing oxygen to said cathode during said applying to cause said oxygen to form oxide ions in said molten electrolyte near said cathode,
wherein said applying and said providing forms a first solution of higher oxide anion activity at said cathode and a second solution of lower oxide anion activity at said anode.

2. The electrochemical process of claim 1, wherein said potential is applied until concentration of ions in said first solution exceeds that in said second solution by at least a factor of 1.5.

3. The electrochemical process of claim 2, further comprising generating an alkaline precipitate and an acidic precipitate from said first solution and said second solution respectively.

4. The electrochemical process of claim 2, further comprising separating the second solution from the first solution.

5. The electrochemical process of claim 4, reacting the first solution with carbon dioxide to form a carbonate mineral.

6. The electrochemical process of claim 5, further comprising cooling said first solution to form a first precipitate, wherein said first precipitate is reacted with said carbon dioxide to form said carbonate mineral.

7. The electrochemical process of claim 4, mixing the first solution with a plurality of constituents to form a cement.

8. The electrochemical process of claim 1, further comprising cooling a cell housing the anode, the cathode and the electrolyte by a fluid;
using the fluid in a thermal cycle to extract carbon dioxide from air.

9. The electrochemical process of claim 1, wherein oxygen is formed at said anode during said applying, wherein said formed oxygen is channeled to said cathode for said providing.

10. An electrochemical cell comprising:
an anode;
a cathode;
a molten electrolyte in which the anode and the cathode are placed; and
an electrical source to apply potential between the anode and the cathode,
wherein oxygen is supplied to said cathode in addition, to form a first solution of higher oxide anion activity at said cathode and a second solution of lower oxide anion activity at said anode, wherein said potential is applied until concentration of ions in said first solution exceeds that in said second solution by at least a factor of 1.5.
